(19) United States
(12) Patent Application Publication
(10) Pub. No.: US 2012/0069711 A1
(43) Pub. Date: Mar. 22, 2012

(54) TERMINAL DEVICE, MOBILE TERMINAL, AND NAVIGATION PROGRAM

(75) Inventors: Kaori ENDO, Kawasaki (JP); Yoshiteru TSUCHINAGA, Fukuoka (JP)

(73) Assignee: FUJITSU LIMITED, Kawasaki-shi (JP)

(21) Appl. No.: 13/118,128

(22) Filed: May 27, 2011

(30) Foreign Application Priority Data
Sep. 22, 2010 (JP) 2010-212825

(51) Int. Cl. G01S 15/02

(52) U.S. Cl. 367/95

(57) ABSTRACT

A terminal device includes an orientation calculating unit that calculates the orientation of a device with respect to the target. Furthermore, the terminal device also includes a degree-of-processing determining unit that determines the degree of processing related to an attribute of a sound that indicates the target in accordance with the orientation calculated by the orientation calculating unit. Furthermore, the terminal device also includes an output control unit that controls an output of a sound in accordance with the degree of processing determined by the degree-of-processing determining unit.

### CROSS-REFERENCE TO RELATED APPLICATION

This application is based upon and claims the benefit of priority of the prior Japanese Patent Application No. 2010-212825, filed on Sep. 22, 2010, the entire contents of which are incorporated herein by reference.

### FIELD

The embodiments discussed herein are directed to a terminal device, a mobile terminal, and a navigation program.

### BACKGROUND

There is a known navigation technology for guiding users to target locations by transferring the target locations to the users. When such navigation is performed, the target locations are transferred via, in addition to video images, sounds in order for the locations to be intuitively perceived. The “target” mentioned here can be any targets as long as users reach their desired destinations, including sites, persons, and mobile units.

One example of a navigation device is the remaining-distance switching type described here. This type of navigation device divides, for each nearby directional point, the remaining distance from its own vehicle to a nearby directional point into multiple sections and stores, as sets of sound effects, a sound effect allocated to each section. Then, from among the sets of sound effects associated with the nearby directional points extracted from map data, the remaining-distance switching type navigation device performs guidance by replaying the sound effect of a section corresponding the distance from its own vehicle to a nearby directional point. Accordingly, even when the nearby directional points are continuously present, the remaining distance to each nearby directional point is guided.

Another example of a navigation device is the vehicle-speed switching type described here. This type of navigation device performs the guidance by determining, in accordance with vehicle speed, the number of types of the series of sound effects for the guidance that is replayed until the vehicle reaches the directional point and by replaying the determined types of the series of sound effects for guidance. Accordingly, a sense of the distance to the directional point can be easily recognized.

Another example of a navigation device is the sound image localization type described here. This type of navigation device outputs, from a plurality of speakers arranged in a vehicle cabin, a sound associated with the target, i.e., a sound icon to allow drivers to recognize the target. For example, by controlling the sound level and the delay time of the sound that is output from each speaker, the sound image localization type navigation device locates a sound image of the sound icon on the target or near the target. Furthermore, the sound image localization type navigation device adds reverberation to the sound icon in accordance with the distance to the target. In this way, the drivers can accurately grasp the target location by using their hearing.
Patent Document 1: Japanese Laid-open Patent Publication No. 2008-286749
Patent Document 2: Japanese Laid-open Patent Publication No. 2008-292235
Patent Document 3: Japanese Laid-open Patent Publication No. 2003-156352

However, with the conventional technologies described above, as will be described below, there is a problem in that it is not possible to accurately transfer the target direction.

For example, both the remaining-distance switching type navigation devices and the vehicle-speed switching type navigation devices only transfer a sense of the distance to the target. Accordingly, even when a user grasps how far away from the target he/she is, the user may not grasp the direction of the target.

Furthermore, the sound image localization type navigation device transfers the direction of the target by locating the sound image of the sound icon on the target or near the target. However, even when the sound image of the sound icon is located on the target or near the target, a user may not perceive a slight difference between the directions; therefore, the direction of the target is roughly transferred to the user. Specifically, even if the target is located in front of a user, the user may not distinguish sounds output from the speakers indicating whether the target is located in front of the user or whether the target is located slightly away from the front of the user. Furthermore, if a user changes his or her own traveling direction, the user may not distinguish sounds, i.e., whether the target is closer to the front of the user or whether the target is shifted from the front of the user.

### SUMMARY

According to an aspect of an embodiment of the invention, a terminal device includes:a calculating unit that calculates an orientation of a device with respect to a target; a determining unit that determines a degree of processing related to an attribute of a sound that indicates the target in accordance with the orientation calculated by the calculating unit; and an output control unit that controls output of the sound in accordance with the degree of processing determined by the determining unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating the configuration of a terminal device according to a first embodiment;

FIG. 2A is a schematic diagram illustrating an example of processing the distance to a sound source;

FIG. 2B is a schematic diagram illustrating an example of processing the distance to the sound source;

FIG. 3 is a schematic diagram illustrating the measurement of a transfer characteristic;

FIG. 4 is a flowchart illustrating the flow of a navigation process according to the first embodiment;

FIG. 5A is a schematic diagram illustrating an example of processing the direction of the sound source;

FIG. 5B is a schematic diagram illustrating an example of processing the direction of the sound source;

FIG. 6 is a schematic diagram illustrating an example of processing a sound volume;

FIG. 7 is a schematic diagram illustrating an example of processing the pitch of a sound;

FIG. 8 is a schematic diagram illustrating an example of processing the tempo of a sound;

FIG. 9 is a schematic diagram illustrating an example of gain being applied to a frequency component of a guiding sound;

FIG. 10 is a schematic diagram illustrating an example of processing the frequency characteristic of a sound;

FIG. 11 is a schematic diagram illustrating the frequency characteristic of a sound and a regression line;

FIG. 12 is a schematic diagram illustrating an example of gain being applied to the frequency component of a guiding sound;

FIG. 13 is a schematic diagram illustrating an example of processing the frequency characteristic of a sound;

FIG. 14 is a schematic diagram illustrating an example of processing the bandwidth of a sound;

FIG. 15 is a schematic diagram illustrating an example of processing the SNR of a sound; and

FIG. 16 is a schematic diagram illustrating an example of the hardware configuration of the terminal device.

### DESCRIPTION OF EMBODIMENTS

Preferred embodiments of the present invention will be explained with reference to accompanying drawings. The embodiments are not limited to the disclosed technology. Furthermore, the embodiments can be appropriately used in combination as long as processes do not contradict.

### [a] First Embodiment

### Configuration of a Terminal Device

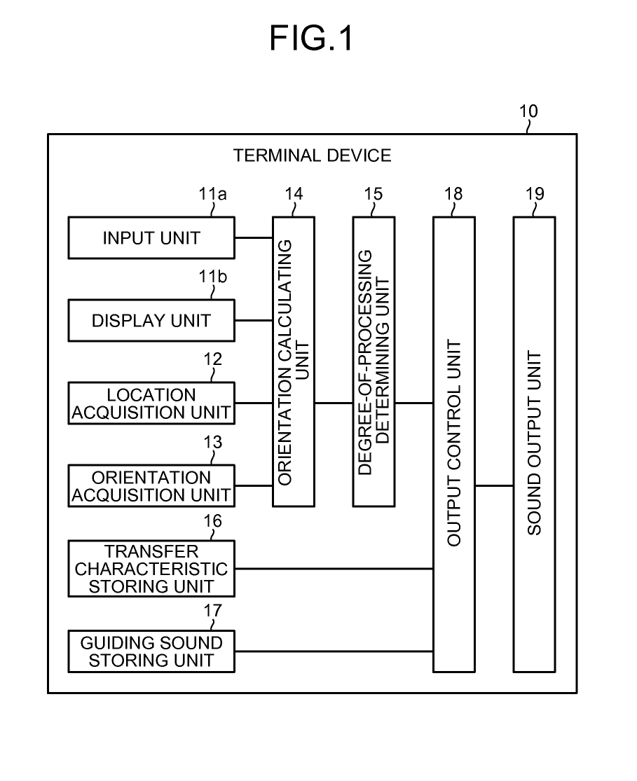

FIG. 1 is a block diagram illustrating the configuration of a terminal device according to a first embodiment. A terminal device 10 illustrated in FIG. 1 guides a user to the target by transferring the location of the target to the user and, in particular, by accurately transferring the direction of the target using a sound. The “target” mentioned here can be any targets as long as users reach their desired destinations including, sites, persons, and mobile units.

Specifically, when a sense of direction to the target is given to a user by using a sound, by making the degree of processing related to the attribute of a sound large as the target is shifted from the front of the terminal device 10, the terminal device 10 according to the embodiment enhances any shift from the front of the terminal device 10. Accordingly, the terminal device 10 according to the embodiment can output a guiding sound such that a user can easily perceive whether the target faces the front of the user or whether the target is moving closer to the front of the user. Therefore, the terminal device 10 according to the embodiment can accurately transfer the direction of the target.

Any information processing apparatus can be used for the terminal device 10 as long as a navigation function can be installed. The terminal device 10 can be implemented by various devices described below. Examples of the terminal device 10 include, as a mobile unit that is a terminal carried by a user, a mobile phone, a personal handyphone system (PHS), and a personal digital assistant (PDA). Another example of the terminal device 10 includes, as a terminal installed in a mobile unit in a vehicle, a navigation device. Furthermore, the terminal device 10 does not necessarily have to be a mobile terminal; a fixed terminal, such as a personal computer, can also be used.

As illustrated in FIG. 1, the terminal device 10 includes an input unit 11a, a display unit 11b, a location acquisition unit 12, an orientation acquisition unit 13, an orientation calculating unit 14, a degree-of-processing determining unit 15, a transfer characteristic storing unit 16, a guiding sound storing unit 17, an output control unit 18, and a sound output unit 19. In addition to the functioning units illustrated in FIG. 1, various functioning units can be installed in the terminal device 10 in accordance with the implementation mode of the terminal device 10. For example, if the terminal device 10 is used as a mobile terminal carried by a user, the terminal device 10 includes a wireless communication unit that communicates using carrier.

The input unit 11a is an input device (device) that receives instruction inputs related to various kinds of information. Specifically, the input unit 11a receives, via an operation performed by a user, a navigation function and the starting and the ending of the navigation function. Furthermore, the input unit 11a receives the setting of the target that is guided and is desired by a user. Various operation keys can be used for the input unit 11a. Examples of the input unit 11a include a numeric keypad (ten key) that is used to input numerals or characters, a cursor key that is used to select a menu or to scroll the screen window, or the like. Furthermore, for the input unit 11a, a touch panel integrated with the display unit 11b, which will be described later, can also be used.

The display unit 11b is a display device that displays various kinds of information. For example, the display unit 11b sets the target or displays map data so that the target can be confirmed on the screen. Examples of the display unit 11b include a monitor, a display, and a touch panel.

In the following, a description is given on the basis of the assumption that a user carrying the terminal device 10 uses the navigation function installed in the terminal device 10 to receive a guiding service to the target. Furthermore, the description is given on the basis of the assumption that, as an example of setting the target, the navigation function is started when a user operates the input unit 11a, map data is displayed on the screen by the display unit 11b, and a landmark or an intersection is set as a target. Here, a case is assumed in which a target on a map is received; however, the target on the map does not necessarily have to be received. For example, if the terminal device 10 is a communication device, such as a mobile phone or a PHS, it is also possible to automatically set, as the target, another communication device that is in a call connection with the terminal device 10. In such a case, the direction in which a person who carries the other communication device, for example, a person to be met, is located is transferred using a sound.

The location acquisition unit 12 is a processing unit that acquires the location of the terminal device 10 and the target location. To acquire the location of the terminal device 10, the location acquisition unit 12 measures, using a Global Positioning System (GPS) receiver, latitude and longitude of a point where the terminal device 10 is located. Then, the location acquisition unit 12 calculates, from the measured latitude and longitude, a coordinate location in plane rectangular coordinates and acquires the location of the terminal device 10. Furthermore, to acquire the target location, the location acquisition unit 12 acquires, as the target location, the plane rectangular coordinates of the target of the map data specified via the input unit 11a.

If the location of the terminal device 10 in the plane rectangular coordinates is acquired using the latitude and the longitude, the conventional technology described here can be used. One example of such a technology is disclosed in “TOTAL INVERSE SOLUTIONS FOR THE GEODESIC AND GREAT ELLIPTIC” B. R. Bowring Survey Review 33, 261 (July, 1996) 461-476.

The orientation acquisition unit 13 is a processing unit that acquires the orientation of the terminal device 10. For example, by using an electromagnetic compass, the orientation acquisition unit 13 acquires, as the orientation of the terminal, the direction indicated by the central vertical axis of the terminal device 10 on a horizontal plane, for example, an angle A formed by the longitudinal direction of the terminal device and the north direction (0°). Alternatively, by extracting the track of the terminal device 10 using the GPS receiver, the orientation acquisition unit 13 can acquire, as the orientation of the terminal, the angle A formed by the traveling direction of the terminal device 10 and the north direction (0°). In the two examples described above, an angle is acquired using the north direction (0°) as a reference direction; however, the direction is not limited thereto. The disclosed terminal device can use any direction as a reference direction.

In the above description, the orientation of the terminal is acquired on the basis of the assumption that the orientation of the terminal and the front-facing direction of a user are the same. However, when the terminal device 10 is used as a communication device by placing it in a user's ear, the orientation of the terminal and the front-facing direction of a user are not always the same. In such a case, any technology can be used in which the orientation of the terminal is corrected to calculate the front-facing direction of a user.

The orientation calculating unit 14 is a processing unit that calculates the orientation of the terminal with respect to the target. For example, in accordance with the location of the terminal device 10 and the target location acquired by the location acquisition unit 12, the orientation calculating unit 14 acquires the direction from the terminal device 10 to the target. Furthermore, the orientation calculating unit 14 acquires, as the site direction of the target, an angle B formed by the site direction of the target and the north direction) (0°. Then, in accordance with the angle B, which is the site direction of the target acquired in this way, and in accordance with the angle A, which is acquired as the orientation of the terminal by the orientation acquisition unit 13, the orientation calculating unit 14 acquires the orientation of the terminal device 10 with respect to the target, for example, “angle B-angle A”.

The degree-of-processing determining unit 15 is a processing unit that determines the degree of processing related to the attribute of a sound indicating the target in accordance with the orientation of the terminal with respect to the target calculated by the orientation calculating unit 14, i.e., in accordance with an orientation Φ (t) of a user with respect to the target.

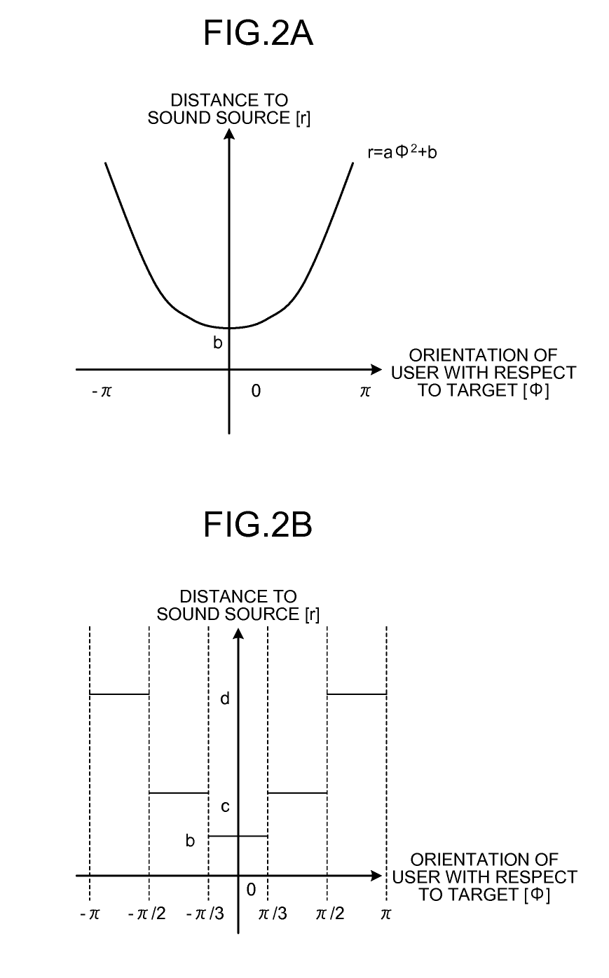

An example is described of a case in which the target direction is transferred by processing the distance (r) to the sound source of the attribute of a sound. The “distance to the sound source” mentioned here indicates the distance from the location in which the terminal device 10 is located to the location in which a virtual sound source is arranged. The “degree of processing” indicates the degree of the distance to the sound source. FIGS. 2A and 2B are schematic diagrams illustrating examples of processing the distance to a sound source. The lateral axes of the graphs illustrated in FIGS. 2A and 2B indicate the orientation (Φ) of a user with respect to the target. The vertical axes of the graphs illustrated in FIG. 2A and FIG. 2B indicate the distance (r) to the sound source. In both the examples illustrated in FIG. 2A and FIG. 2B, a case is assumed in which, when the target is located in front of the user, i.e., Φ (t)=0, the distance to the sound source is set to the minimum (r=b). The magnitude relation among b, c, and d in FIG. 2B is assumed to be “b<c<d”.

In the example illustrated in FIG. 2A, in accordance with the quadratic function “r=aΦ²+b”, the degree-of-processing determining unit 15 determines the distance to the sound source. Specifically, as the absolute value of the orientation (Φ) of a user with respect to the target increases, the degree-of-processing determining unit 15 increases, by increasing the distance (r) to the sound source, the degree of deviation of the distance (r) from an intercept b. At this time, the slope a of the quadratic function is set high if a user directly faces the target. It is possible to allow a user to perceive a sound only when the user substantially faces the target and to allow a user to roughly perceive a sound by making the sound source move away from the user when the user does not substantially face the target. Accordingly, when the state is such that the target is shifting from the front of the user or when the target becomes shifted from the front of the user, this state can be enhanced. For example, the slope a of the quadratic function is preferably set to 2, which is greater than 1, from the viewpoint of enhancing the shift from the front. Furthermore, an intercept b of the quadratic function is preferably set to a value, for example, “1 m”, such that a user can perceive the sound source at a short distance. The example described above is only for an example; any given value can be set to the slope a and the intercept b of the quadratic function.

In the example illustrated in FIG. 2B, the degree-of-processing determining unit 15 gradually increases the distance (r) to the sound source as the absolute value of the orientation (Φ) of a user with respect to the target increases. Specifically, in the range of “−π/≦Φ<π/3”, i.e., if the target is in front of a user or is substantially in front of the user, the degree-of-processing determining unit 15 sets the distance to the sound source to the minimum (r=b). Furthermore, in the range of “−π/2≦Φ<−π/3” and in the range of “π/3≦Φ<π/2”, i.e., if the target is slightly shifted from the front of a user, the degree-of-processing determining unit 15 sets the distance to the sound source to c (>b). Furthermore, in the range of “−π≦Φ<−π/2” and in the range of “π/2≦Φ<π”, i.e., if the target is significantly shifted from the front of the user, the degree-of-processing determining unit 15 sets the distance to the sound source to d (>c). Accordingly, the user can perceive, in stages, whether the user faces the target without perceiving the slight difference between the distances to the sound source. Accordingly, when the state is such that the target is shifting from the front of the user or becomes shifted from the front of the user, this state can be enhanced. In the example illustrated in FIG. 2B, an example is described of a case in which the distances to the sound source is set to three stages; however, any number of stages can be set for the distance to the sound source.

The transfer characteristic storing unit 16 is a storing unit that stores therein a transfer characteristic. To position the sound source at a given location by performing a convolution of the head-related transfer function, transfer characteristics that are previously measured for each of the left and the right ears are registered in the transfer characteristic storing unit 16. The convolution is performed by the output control unit 18, which will be described later.

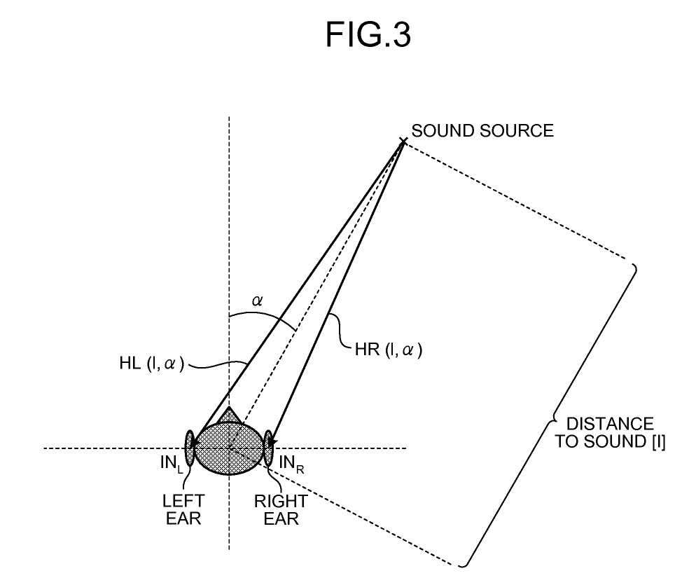

FIG. 3 is a schematic diagram illustrating the measurement of a transfer characteristic. The symbol HL (1, α) illustrated in FIG. 3 indicates a transfer characteristic from the sound source to the left ear. The symbol HR (1, α) illustrated in FIG. 3 indicates a transfer characteristic from the sound source to the right ear. The symbol IN_{L} illustrated in FIG. 3 indicates an output sound for the left ear. The symbol IN_{R} illustrated in FIG. 3 indicates an output sound for the right ear. As illustrated in FIG. 3, for the location of the virtual sound source, i.e., for the distance (1) and the orientation (α), the transfer characteristic HL (1, α) to the left ear and the transfer characteristic HR (1, α) to the right ear, which are previously measured for each of the left and the right ears, are registered in the transfer characteristic storing unit 16. The transfer characteristic HL (1, α) and the transfer characteristic HR (1, α) are measured by changing both the distance (1) and the orientation (α) such that transfer characteristics of the location in which the virtual sound source is to be positioned are included. The transfer characteristic HL (1, α) and the transfer characteristic HR (1, α) are calculated, by the output control unit 18 that will be described later, using a head-related transfer function (HRTF) of the left and the right ears and then are used to create an output sound for the left ear IN_{L} and an output sound for the right ear IN_{R}.

The guiding sound storing unit 17 is a storing unit that stores therein a guiding sound that is used to guide a user to the target. It is possible to previously register, in the guiding sound storing unit 17, an electronic sound, for example, a “beeping sound . . . ”. Alternatively, a desired tune can be preinstalled or can be downloaded and then installed. Any kinds of sounds can be used for the guiding sound as long as a person can perceive it.

The output control unit 18 is a processing unit that controls the output of a sound indicating the target. The output is performed in accordance with the degree of processing related to the attribute of the sound determined by the degree-of-processing determining unit 15. For example, from among the transfer characteristics stored in the transfer characteristic storing unit 16, the output control unit 18 extracts the transfer characteristics closest to the distance (r) to the sound source determined by the degree-of-processing determining unit 15. Specifically, the output control unit 18 extracts a transfer characteristic HL (1, α) and a transfer characteristic HR (1, α) in which the difference between the distances to the sound source is |1−r|. Then, the output control unit 18 performs, on the transfer characteristic HL (1, α) and the transfer characteristic HR (1, α), frequency-time conversion, i.e., a Fourier transformation. Accordingly, the output control unit 18 solves a head-related transfer function of each of the left and the right ears, i.e., calculates an impulse response hrtf L (1, α, m) and hrtf R (1, α, m), where m is the length of the impulse response and m=0, . . . M−1, and M. Then, by using a finite impulse response (FIR) filter, the output control unit 18 performs convolution indicated Equation (1) and Equation (2) below. Specifically, the output control unit 18 convolves an impulse response hrtf L (1, α, m) to the left ear and an impulse response hrtf R (1, α, m) to the right ear with a guiding sound signal sig (n) extracted from the guiding sound storing unit 17. In this way, after creating the stereo signals of the output sound for the left ear IN_{L} and the stereo signals of the output sound for the right ear IN_{R}, the output control unit 18 outputs the stereo signal to the sound output unit 19.

$$\begin{matrix}in\_L ( l , a , n ) = {\sum }_{m = 0}^{M - 1} hrtfL ( l , a , m ) \cdot sig ( n - m ) & ( 1 ) \\ in\_ R ( l , a , n ) = {\sum }_{m = 0}^{M - 1} hrtfR ( l , a , m ) \cdot sig ( n - m ) & ( 2 )\end{matrix}$$

The sound output unit 19 is a sound output device that outputs a sound signal that is output by the output control unit 18. A speaker or an earphone can be used for the sound output unit 19. Specifically, when sounds are output via speakers, the sound output unit 19 outputs, from multiple speakers, output sounds for the left ear IN_{L} from a left speaker L and an output sound for the right ear IN_{R} from a right speaker R. Furthermore, when a sound is output via earphones, the sound output unit 19 outputs an output sound for the left ear IN_{L} from a left earphone L and an output sound for the right ear IN_{R} from a right earphone R.

The terminal device 10 described above includes, for example, a semiconductor memory device, such as a random access memory (RAM) or a flash memory, which is used for various processes. Furthermore, the terminal device 10 also includes an electronic circuit, such as a central processing unit (CPU) or a micro processing unit (MPU), and executes various processes using the RAM or the flash memory. Instead of the CPU or the MPU, the terminal device 10 can include an integrated circuit, such as an application specific integrated circuit (ASIC) or a field programmable gate array (FPGA).

Flow of a Process

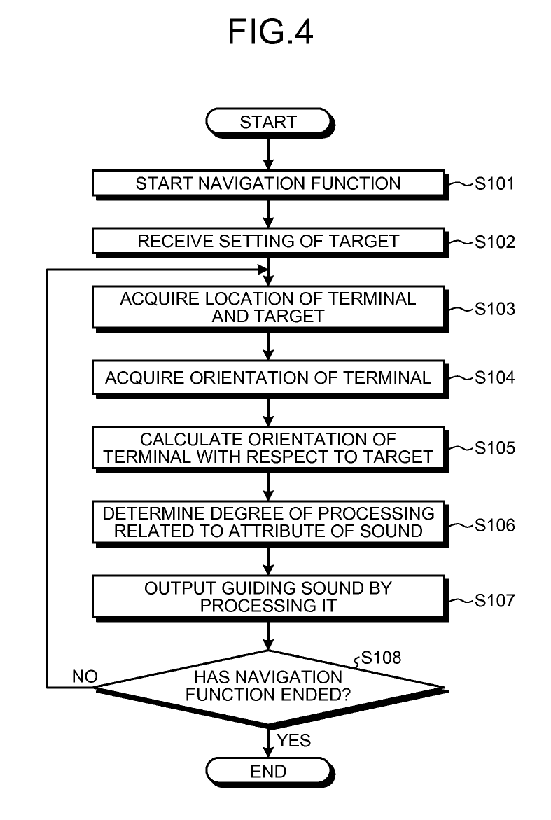

In the following, the flow of the terminal device according to the embodiment will be described. FIG. 4 is a flowchart illustrating the flow of a navigation process according to the first embodiment. The navigation process starts, via the input unit 11a, when the starting of a navigation function is received.

As illustrated in FIG. 4, when the starting of the navigation function is received (Step S101), the input unit 11a receives the setting of the target on the screen on which map data is displayed by the display unit 11b (Step S102).

Then, the location acquisition unit 12 acquires the location of the terminal device 10 and the location of the target (Step S103). Thereafter, the orientation acquisition unit 13 acquires the orientation of the terminal device 10 (Step S104). Subsequently, after obtaining the site direction of the target by using the location of the terminal device 10 and using the location of the target acquired by the location acquisition unit 12, the orientation calculating unit 14 calculates, from the site direction of the target and the orientation of the terminal that is acquired by the orientation acquisition unit 13, the orientation of the terminal device 10 with respect to the target (Step S105).

Then, in accordance with the orientation of the terminal with respect to the target calculated by the orientation calculating unit 14, i.e., the orientation of a user with respect to the target, the degree-of-processing determining unit 15 determines the degree of processing related to the attribute of a sound that indicates the target (Step S106). Subsequently, in accordance with the degree of processing related to the attribute of the sound determined by the degree-of-processing determining unit 15, the output control unit 18 processes a guiding sound and allows the sound output unit 19 to output the processed guiding sound (Step S107).

Then, processes from Steps S103 to S107 are repeatedly performed until the navigation function ends (No at Step S108). Thereafter, if the navigation function ends (Yes at Step S108), the process ends. The navigation function ends when it receives, from a user via the input unit 11a, an instruction to end the function or automatically ends when the user reaches the target.

### Advantage of the First Embodiment

As described above, the terminal device 10 according to the embodiment calculates the orientation of the terminal device 10 with respect to the target; determines the degree of processing related to the distance to the sound source in accordance with the calculated orientation; and controls the output of the sound in accordance with the degree of processing. Accordingly, a user can perceive whether he or she faces the target without perceiving the slight difference between the distances to the sound source. Accordingly, the terminal device 10 according to the embodiment can accurately transfer the direction of the target.

Furthermore, as the orientation of the front of the terminal device 10 is shifted with respect to the target, the terminal device 10 according to the embodiment increases the degree of processing related to the distance to the sound source. Accordingly, as the target becomes shifted from the front of the terminal device 10, the terminal device 10 according to the embodiment can enhance the shift from the front of the terminal device 10 by making the degree of processing related to the distance to the sound source. Accordingly, the terminal device 10 according to the embodiment can output a guiding sound such that a user can easily perceive whether the target faces the front of the user or whether the target is moving closer to the front of the user. Accordingly, the terminal device 10 according to the embodiment can further accurately transfer the direction of the target.

### [b] Second Embodiment

In the first embodiment described above, a case has been described in which the direction of the target is transferred by processing the distance (r) to the sound source from among the attributes of the sound; however, another attribute of a sound can also be used. Accordingly, in a second embodiment, a case will be described in which the direction of the target is transferred by processing the direction (θ) of the sound source from among the attributes of the sound.

In the second embodiment, the functioning units other than the degree-of-processing determining unit 15 and the output control unit 18 illustrated in FIG. 1 have the same functions as those described in the first embodiment; therefore, a description thereof is omitted here. Furthermore, in the second embodiment, in order to distinguish the terminal device, the degree-of-processing determining unit, and the output control unit described in the first embodiment from those in the second embodiment, a description will be given by assigning reference numeral “20” to a terminal device, reference numeral “21” to a degree-of-processing determining unit, and reference numeral “22” to an output control unit.

The degree-of-processing determining unit 21 determines the degree of processing related to the direction of the sound source in accordance with the orientation of the terminal with respect to the target, i.e., the orientation of a user with respect to the target, calculated by the orientation calculating unit 14. The “direction of the sound source” mentioned here indicates the direction of a virtual sound source to be arranged. The “degree of processing” indicates the degree of the direction of the sound source.

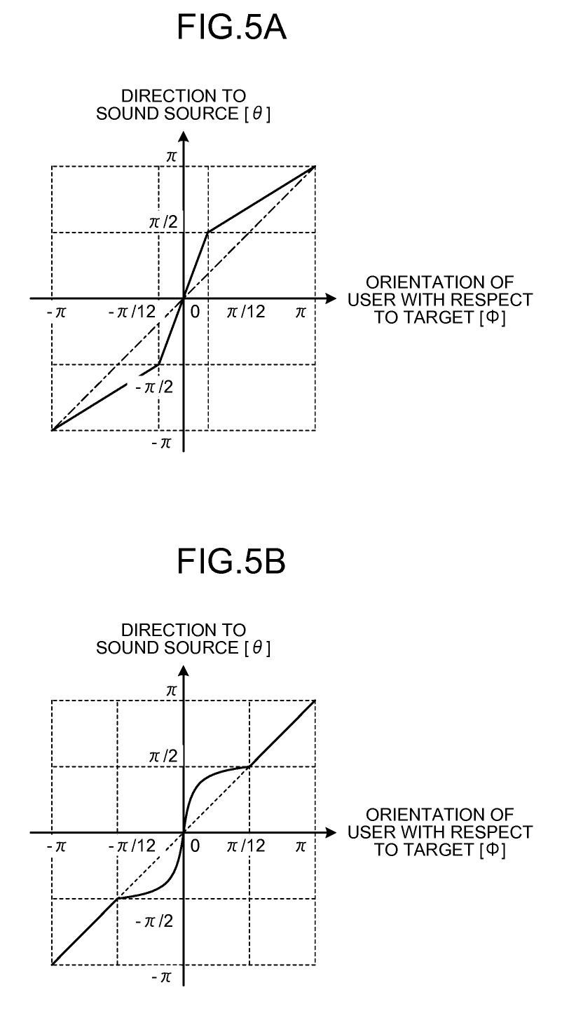

FIGS. 5A and 5B are schematic diagrams illustrating an example of processing the direction of the sound source. The lateral axes of the graph illustrated in FIGS. 5A and 5B indicate the orientation (Φ) of a user with respect to the target. The vertical axes of the graphs illustrated in FIGS. 5A and 5B indicate the direction (θ) of the sound source. In both the examples illustrated in FIGS. 5A and 5B, a case is assumed in which, when the target is located in front of a user, i.e., Φ (t)=0, the direction of the sound source is set to the front (θ=0).

In the example illustrated in FIG. 5A, if the orientation (Φ) of a user with respect to the target satisfies “−π≦Φ<−π/12”, the degree-of-processing determining unit 21 determines the direction (θ) of the sound source in accordance with a function 1 “θ=6Φ/11−5π/11”. If the orientation (Φ) of a user with respect to the target satisfies “−π/12≦Φ<π/12”, the degree-of-processing determining unit 21 determines the direction (θ) of the sound source in accordance with a function 2 “θ=6Φ”. Furthermore, if the orientation (Φ) of a user with respect to the target satisfies “π/12≦Φ<π”, the degree-of-processing determining unit 21 determines the direction (θ) of the sound source in accordance with a function 3 “θ=6Φ/11+5π/11”. Accordingly, in a predetermined range in which a user substantially faces the target, the direction (θ) of the sound source is determined in accordance with the function 3 having the greater slope than that represented by the function 1 and the function 2. Accordingly, even when the target substantially faces a user, the sound source is arranged at a location shifted from the front of the user and thus the sound source is not arranged in front of the user as long as the sound source does not face the user. Therefore, a user can easily perceive that he or she faces the target.

In the example illustrated in FIG. 5B, if the orientation (Φ) of a user with respect to the target satisfies “−π≦Φ<−π/2” and “π/2≦Φ<π”, the degree-of-processing determining unit 21 determines the direction (θ) of the sound source in accordance with the function 4 “θ=Φ”. Furthermore, if the orientation (Φ) of a user with respect to the target satisfies “−π/2≦Φ<π/2”, the degree-of-processing determining unit 21 determines the direction (θ) of the sound source in accordance with the nonlinear function 5 in which the slope is greater than that of the function 4. Accordingly, similarly to the example illustrated in FIG. 5A, even when the target substantially faces a user, the sound source is arranged at a location shifted from the front of the user and thus the sound source is not arranged in front of the user as long as it does not face the user. Accordingly, a user can easily perceive that he or she faces the target.

The output control unit 22 creates a stereo signal by convolving an impulse response that is used to position the direction (θ) of the sound source determined by the degree-of-processing determining unit 21 with the guiding sound stored in the guiding sound storing unit 17. Specifically, from among the transfer characteristics stored in the transfer characteristic storing unit 16, the output control unit 22 extracts transfer characteristics closest to the direction (θ) of the sound source determined by the degree-of-processing determining unit 21. More specifically, the output control unit 22 extracts a transfer characteristic HL (1, α) and a transfer characteristic HR (1, α) in which the difference between the distances of the sound source is |α−θ|. Then, the output control unit 22 performs a Fourier transformation on the transfer characteristic HL (1, α) and the transfer characteristic HR (1, α). Accordingly, the output control unit 22 calculates the impulse response hrtf L (1, α, m) for the left ear and the impulse response hrtf R (1, α, m) for the right ear. Then, by using the FIR filter, the output control unit 22 performs a convolution represented by Equation (1) and Equation (2). Specifically, the output control unit 22 convolves the impulse response hrtf L (1, α, m) for the left ear and the impulse response hrtf R (1, α, m) for the right ear with the guiding sound signal sig (n) extracted from the guiding sound storing unit 17. In this way, after creating the stereo signals of the output sound for the left ear IN_{L} and the output sound for the right ear IN_{R}, the output control unit 22 outputs the stereo signal to the sound output unit 19.

### Advantage of the Second Embodiment

As described above, the terminal device 20 according to the second embodiment transfers the direction of the target by processing the direction (θ) of the sound source from among the attributes of the sound. Accordingly, in a similar manner as in the first embodiment, a user can perceive whether the user faces the target without perceiving the slight difference between the directions of the sound source. Accordingly, with the terminal device 20 according to the second embodiment, it is possible to accurately transfer the direction of the target.

Furthermore, if the orientation of the front of a user with respect to the target is within a predetermined range, as the orientation of the front of the user is shifted within the predetermined range, the terminal device 20 according to the second embodiment increases the degree of processing compared with that in the other ranges. Accordingly, even when the target substantially faces the user, the sound source is arranged at a location shifted from the front of the user and thus the sound source is not arranged in front of the user as long as it does not face the user. Accordingly, a user can easily perceive that he or she faces the target. Therefore, the terminal device 20 according to the second embodiment effectively helps a user to face the target.

### [c] Third Embodiment

In the second embodiment, a case has been described in which the direction of the target is transferred by processing the direction (θ) of a sound source from among the attributes of the sound; however, another attribute of a sound can also be used. Accordingly, in a third embodiment, a case will be described in which the direction of the target is transferred by processing a sound volume (V) from among the attributes of a sound.

In the third embodiment, the functioning units other than the degree-of-processing determining unit 15 and the output control unit 18 illustrated in FIG. 1 have the same functions as those described in the first embodiment; therefore, a description thereof is omitted here. Furthermore, in the third embodiment, in order to distinguish the terminal device, the degree-of-processing determining unit, and the output control unit described in the first and second embodiments, a description will be given by assigning reference numeral “30” to a terminal device, reference numeral “31” to a degree-of-processing determining unit, and “32” to an output control unit.

The degree-of-processing determining unit 31 determines the degree of processing related to a sound volume (V) in accordance with the orientation of the terminal with respect to the target calculated by the orientation calculating unit 14. The “degree of processing” mentioned here indicates a control level of the ratio (%) of an output volume with respect to the maximum volume Vmax.

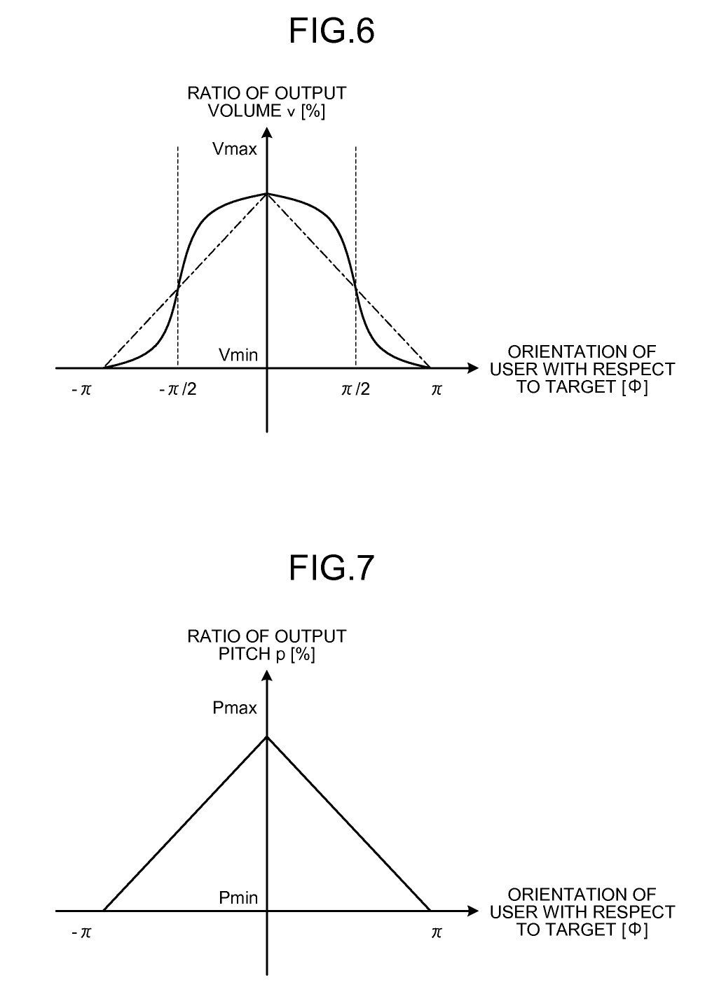

FIG. 6 is a schematic diagram illustrating an example of processing a sound volume. The lateral axis of the graph illustrated in FIG. 6 indicates the orientation (Φ) of a user with respect to the target. The vertical axis of the graph illustrated in FIG. 6 indicates the ratio (v) of an output volume. In the example illustrated in FIG. 6, a case is assumed in which, when the target is located in front of a user, i.e., Φ (t)=0, the ratio (v) of an output volume is set to the maximum ratio (Vmax=100%).

In the example illustrated in FIG. 6, the degree-of-processing determining unit 31 determines the ratio (v) of an output volume in accordance with a calculation equation “v(Φ)=((Vmax-Vmin)/2)sin(Φ+π/2)+(Vmax+Vmin)/2” for the ratio of the output volume. In this calculation equation, if the orientation (Φ) of a user with respect to the target satisfies “−π/2≦Φ<π/2”, the ratio (v) of the output volume becomes as follows. The ratio (v) of the output volume is greater than that obtained when the orientation (Φ) of a user with respect to the target and the ratio (v) of the output volume are linearly changed, i.e., when they are changed in accordance with the dashed line in FIG. 6. In contrast, if the orientation (Φ) of a user with respect to the target satisfies “−π≦Φ<−π/2” or “π/2≦Φ<π”, the ratio (v) of the output volume becomes as follows. The ratio (v) of the output volume is smaller than that obtained when the orientation (Φ) of a user with respect to the target and the ratio (v) of the output volume are linearly changed. Accordingly, it is possible to allow a user to perceive a loud sound only when the user faces or substantially faces the target and is possible to allow a user to perceive a small sound by shifting the sound source away from the user. Accordingly, when the state is such that the target is shifting from the front of a user or becomes shifted from the front of the user, this state can be enhanced.

The output control unit 32 changes a guiding sound volume stored in the guiding sound storing unit 17 in accordance with the ratio of the output volume determined by the degree-of-processing determining unit 31. Specifically, the output control unit 32 attenuates a sound signal of a guiding sound in accordance with a calculation equation “es (t)=s(t)×v/100” for the output volume and outputs the attenuated sound signal of the guiding sound to the sound output unit 19. The symbol “es (t)” mentioned here indicates a processed guiding sound sample. Furthermore, the symbol “s (t)” indicates a pre-processed guiding sound sample.

### Advantage of the Third Embodiment

As described above, the terminal device 30 according to the third embodiment transfers the direction of the target by processing a sound volume (V) from among the attributes of the sound. Accordingly, in a similar manner as in the first embodiment, a user can perceive whether he or she faces the target without perceiving the slight difference between the sound volumes. Accordingly, the terminal device 30 according to the third embodiment can accurately transfer the direction of the target. Furthermore, with the terminal device 30 according to the third embodiment, the volume of a sound can be processed without using the head-related transfer function; therefore, the terminal device 30 can be preferably used not only when a stereo output is used but also when a monophonic output is used.

### [d] Fourth Embodiment

In the third embodiment, a case has been described in which the direction of the target is transferred by processing the sound volume (V) from among the attributes of the sound; however, another attribute of a sound can also be used. Accordingly, in a fourth embodiment, a case will be described in which the direction of the target is transferred by processing the pitch (P) of a sound from among the attributes of the sound.

In the fourth embodiment, the functioning units other than the degree-of-processing determining unit 15 and the output control unit 18 illustrated in FIG. 1 have the same functions as those described in the first embodiment; therefore, a description thereof is omitted here. Furthermore, in the fourth embodiment, in order to distinguish the terminal device, the degree-of-processing determining unit, and the output control unit described in the fourth embodiment from those in the first to third embodiments, a description will be given by assigning reference numeral “40” to a terminal device, reference numeral “41” to a degree-of-processing determining unit, and reference numeral “42” to an output control unit.

The degree-of-processing determining unit 41 determines the degree of processing related to the pitch (P) of a sound in accordance with the orientation of the terminal with respect to the target, i.e., the orientation of a user with respect to the target, calculated by the orientation calculating unit 14. The “degree of processing” mentioned here indicates a control level of the ratio (%) of on output pitch with respect to the maximum pitch Pmax. The maximum pitch Pmax is assumed to be a tone of the original sound.

FIG. 7 is a schematic diagram illustrating an example of processing the pitch of a sound. The lateral axis of the graph illustrated in FIG. 7 indicates the orientation (Φ) of a user with respect to the target. The vertical axis of the graph illustrated in FIG. 7 indicates the ratio (p) of the output pitch. In the example illustrated in FIG. 7, a case is assumed in which, when the target is located in front of a user, i.e., Φ (t)=0, the ratio (p) of the output pitch is set to the maximum ratio (Pmax=100%).

In the example illustrated in FIG. 7, if the orientation (Φ) of a user with respect to the target satisfies “0≦Φ”, the degree-of-processing determining unit 41 determines the ratio of the output pitch in accordance with calculation equation 3 “p(Φ)=Pmax+(Pmin−Pmax)Φ/π” for the ratio (p) of the output volume. Furthermore, if the orientation (Φ) of a user with respect to the target satisfies “Φ<0”, the degree-of-processing determining unit 41 determines the ratio of the output pitch in accordance with calculation equation 4 “p(Φ)=Pmin+(Pmax−Pmin)Φ/π” for the ratio (p) of the output volume. Accordingly, a user can perceive whether he or she faces the target without perceiving the slight difference between the sound pitches. It is possible to use calculation equation “p (Φ))=((Pmax−Pmin)/2)sin(Φ+π/2)+(Pmax+Pmin)/2” for the ratio (p) of the output pitch, which is similar to the calculation equation of the ratio (v) of the output volume described in the third embodiment.

The output control unit 42 changes, in accordance with the output pitch determined by the degree-of-processing determining unit 41, the pitch of the guiding sound stored in the guiding sound storing unit 17. Specifically, the output control unit 42 acquires a frequency component by performing, on a sound signal of the guiding sound stored in the guiding sound storing unit 17, a time frequency conversion, i.e., an inverse Fourier transformation. Such a frequency component is represented as a complex number for each frequency (Hz). In the following, a description will be given by representing the number of divisions of a frequency component divided by a predetermined bandwidth (hereinafter, referred to as the “number of bandwidth divisions”) as N and by representing the k^{th} (k=0, . . . , N−1) bandwidth frequency component as S (k). By using a ROUND function that outputs an integer by rounding off decimals, the output control unit 42 decreases the frequency component of the guiding sound by the value of the ratio p (Hz) of the output pitch. Specifically, by using “j=round(p/Δf)” and “Δf·f(k)−f(k−1)”, the output control unit 42 calculates S′(k)=S(k+j)0 for “k=0, N−j−1” and calculates S′(k)=0 for “k=N−j, . . . , N−1”. Then, by performing a frequency-time conversion on S′ (k), the output control unit 42 creates a sound signal of a guiding sound whose frequency component decreases by the value of the ratio p (Hz) of the output pitch.

### Advantage of the Fourth Embodiment

As described above, the terminal device 40 according to the fourth embodiment transfers the direction of the target by processing the pitch (P) of a sound from among the attributes of the sound. Accordingly, in a similar manner as in the first embodiment, a user can perceive whether he or she faces the target without perceiving the slight difference between the pitches of the sound. Accordingly, the terminal device 40 according to the fourth embodiment can accurately transfer the direction of the target. Furthermore, the terminal device 40 according to the fourth embodiment can processes the pitch without using the head-related transfer function; therefore, the terminal device 40 can be preferably used not only when a stereo output is used but also when a monophonic output is used.

### [e] Fifth Embodiment

In the fourth embodiment, a case has been described in which the direction of the target is transferred by processing the pitch (P) of a sound from among the attributes of the sound; however, another attribute of a sound can also be used. Accordingly, in a fifth embodiment, a case will be described in which the direction of the target is transferred by processing the tempo (T) of a sound from among the attributes of the sound.

In the fifth embodiment, the functioning units other than the degree-of-processing determining unit 15 and the output control unit 18 illustrated in FIG. 1 have the same functions as those described in the first embodiment; therefore, a description thereof is omitted here. Furthermore, in the fifth embodiment, in order to distinguish the terminal device, the degree-of-processing determining unit, and the output control unit described in the fifth embodiment from those in the first to fourth embodiments, a description will be given by assigning reference numeral “50” to a terminal device, reference numeral “51” to a degree-of-processing determining unit, and reference numeral “52” to an output control unit.

The degree-of-processing determining unit 51 determines the degree of processing related to the tempo (T) of a sound in accordance with the orientation of the terminal with respect to the target, i.e., the orientation of a user with respect to the target, calculated by the orientation calculating unit 14. The “degree of processing” mentioned here indicates a control level of the ratio (%) of an output tempo with respect to the maximum tempo T max. The maximum tempo T max is assumed to be the tempo of the original sound.

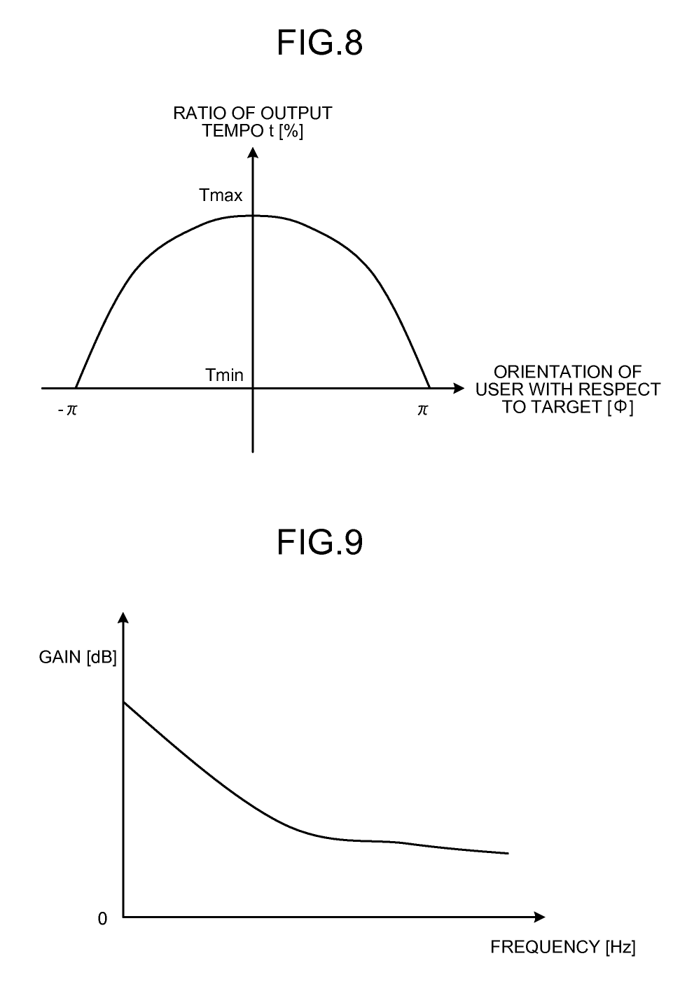

FIG. 8 is a schematic diagram illustrating an example of processing the tempo of a sound. The lateral axis of the graph illustrated in FIG. 8 indicates the orientation (Φ) of a user with respect to the target. The vertical axis of the graph illustrated in FIG. 8 indicates the ratio (t) of an output tempo. In the example illustrated in FIG. 8, a case is assumed in which, when the target is located in front of a user, i.e., Φ (t)=0, the ratio (t) of an output tempo is set to the maximum tempo (Tmax=100%).

In the example illustrated in FIG. 8, the degree-of-processing determining unit 51 determines the ratio (t) of the output tempo in accordance with the calculation equation “t(Φ)=(Tmax−Tmin)sin(Φ)/2+π/2)+Tmin” for the ratio (t) of the output tempo. Specifically, as the absolute value of the orientation (Φ) of a user with respect to the target increases, the degree-of-processing determining unit 51 increases the control level of the ratio (t) of the output tempo. If the ratio (t) of the output tempo is determined in this way, it is possible to allow a user to perceive a natural sound at an original speed only when the user faces or substantially faces the target. In contrast, when the user does not face nor substantially face the target, it is possible to allow the user to slowly perceive a sound by decreasing the sound compared with the original sound. Accordingly, when the state is such that the target is shifting from the front of a user or becomes shifted from the front of the user, this state can be enhanced.

The output control unit 52 changes the tempo of the guiding sound stored in the guiding sound storing unit 17 in accordance with the ratio of the output tempo determined by the degree-of-processing determining unit 51. Specifically, by applying the following conventional technology to the output control unit 52, it is possible to change the tempo of the sound signal of the guiding sound. An example of the conventional technology is disclosed in the following publication: Sadaoki Furui, “speech information processing-electronic information communication engineering series” Morikita publishing Co., Ltd., in which a time-domain harmonic scaling (TDHS) is described as a method of converting a tempo using a signal waveform.

### Advantage of the Fifth Embodiment

As described above, the terminal device 50 according to the fifth embodiment transfers the direction of the target by processing the tempo (T) of the sound from among the attributes of the sound. Accordingly, in a similar manner as in the first embodiment, a user can perceive whether he or she faces the target without perceiving the slight difference between the tempos of the sound. Accordingly, the terminal device 50 according to the fifth embodiment can accurately transfer the direction of the target. Furthermore, the terminal device 50 according to the fifth embodiment can process the tempo of the sound without using the head-related transfer function; therefore, the terminal device 50 can be preferably used not only when a stereo output is used but also when a monophonic output is used.

### [f] Sixth Embodiment

In the fifth embodiment, a case has been described in which the direction of the target is transferred by processing the tempo (T) of a sound from among the attributes of the sound; however, another attribute of a sound can also be used. Accordingly, in the sixth embodiment, a case will be described in which the direction of the target is transferred by processing the frequency characteristic of a sound from among the attributes of the sound.

In the sixth embodiment, the functioning units other than the degree-of-processing determining unit 15 and the output control unit 18 illustrated in FIG. 1 have the same functions as those described in the first embodiment; therefore, a description thereof is omitted here. Furthermore, in the sixth embodiment, in order to distinguish the terminal device, the degree-of-processing determining unit, and the output control unit described in the sixth embodiment from those in the first to fifth embodiments, a description will be given by assigning reference numeral “60” to a terminal device, reference numeral “61” to a degree-of-processing determining unit, and “62” to an output control unit.

The degree-of-processing determining unit 61 determines the degree of processing related to the frequency characteristic (T) of a sound in accordance with the orientation of the terminal with respect to the target, i.e., the orientation of the user with respect to the target, calculated by the orientation calculating unit 14.

The “degree of processing” mentioned here indicates the control level of the ratio (%) of a supplied gain with respect to the maximum gain C max that is applied to the frequency component of the guiding sound. FIG. 9 is a schematic diagram illustrating an example of gain being applied to a frequency component of a guiding sound. The lateral axis of the graph illustrated in FIG. 9 indicates the frequency (Hz). The left end thereof indicates the minimum audible value. The vertical axis of the graph illustrated in FIG. 9 indicates gain. The example illustrated in FIG. 9 indicates the maximum gain Cmax applied to the frequency component of the guiding sound. As illustrated in FIG. 9, the maximum gain Cmax is set such that the gain of the frequency bandwidth that can be easily perceived by a human is set to high. Furthermore, the maximum gain Cmax is set such that, by applying the maximum gain Cmax to the sound signal of the guiding sound, the entire sound of the frequency component including the minimum audible value can be heard in an equal manner.

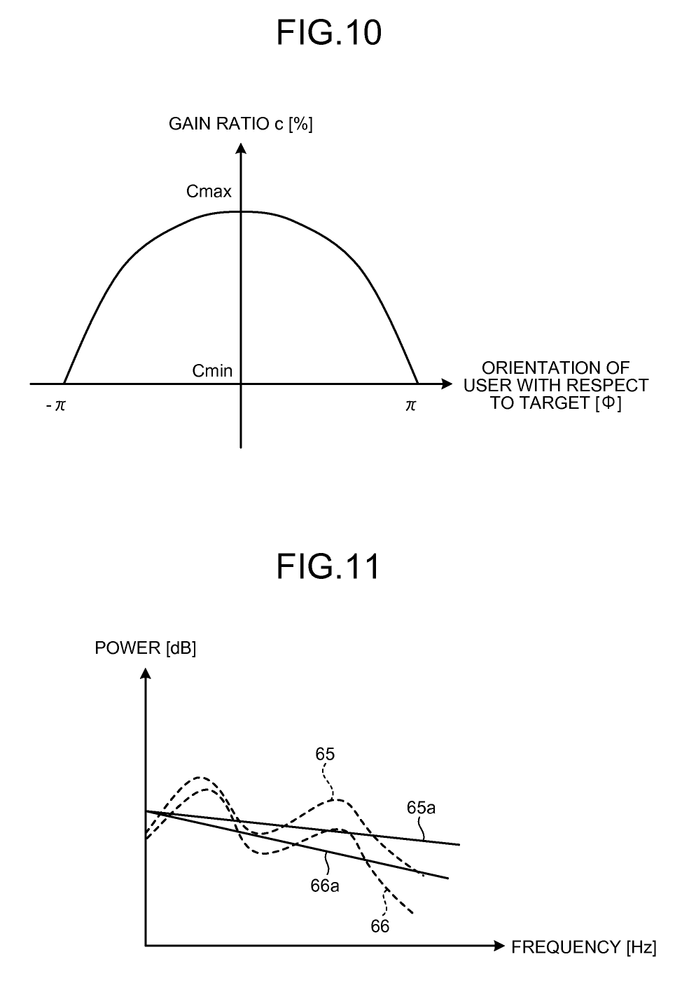

FIG. 10 is a schematic diagram illustrating an example of processing the frequency characteristic of a sound. The lateral axis of the graph illustrated in FIG. 10 indicates the orientation (Φ) of a user with respect to the target. The vertical axis of the graph illustrated in FIG. 10 indicates the ratio (c) of a supplied gain. In the example illustrated in FIG. 10, a case is assumed in which, when the target is located in the front of a user, i.e., Φ (t)=0, the ratio (c) of the supplied gain is set to the maximum gain (Cmax=100%).

In the example illustrated in FIG. 10, the degree-of-processing determining unit 61 determines the ratio (c) of the supplied gain in accordance with the calculation equation “c(Φ)=(Cmax−Cmin)sin(Φ)/2+π/2)+Cmin” for the ratio (c) of the supplied gain. Specifically, as the absolute value of the orientation (Φ) of a user with respect to the target increases, the degree-of-processing determining unit 61 increases the control level of the ratio (c) of the supplied gain. If the ratio (c) of the supplied gain is determined in this way, it is possible to allow a user to quickly perceive a sound only when the user faces or substantially faces the target. In contrast, when the user does not face nor substantially face the target, it is possible to allow the user to perceive a weakened sound by decreasing the gain applied to the original sound. Accordingly, when the state is such that the target is shifting from the front of a user or becomes shifted from the front of the user, this state can be enhanced.

The output control unit 62 changes, in accordance with the ratio of the supplied gain determined by the degree-of-processing determining unit 61, the frequency characteristic of the guiding sound stored in the guiding sound storing unit 17. Specifically, the output control unit 62 calculates a supplied gain e (f) applied to the sound signal of the guiding sound in accordance with the calculation equation “e(f)=10̂((c(Φ)*g(f))/100/20” for the supplied gain. The symbol “g (f)” included in the calculation equation indicates the maximum gain Cmax illustrated in FIG. 9. Then, the output control unit 62 acquires a frequency component by performing a time frequency conversion on the sound signal of the guiding sound stored in the guiding sound storing unit 17. Such a frequency component is represented as a complex number for each frequency (Hz). In the following, a description will be given by representing the number of divisions of frequency component divided by a predetermined bandwidth (hereinafter, referred to as the “number of bandwidth divisions”) as N and representing k^{th} (k=0, . . . , N−1) bandwidth frequency component as S (k). By multiplying the supplied gain e (f) by the frequency component S (k) for each bandwidth of a guiding sound, the output control unit 62 creates a frequency component S″ (k) of a guiding sound to which the gain has been applied. Then, the output control unit 62 performs frequency-time conversion on the frequency component S″ (k) of the guiding sound to which the gain is applied such that the output control unit 62 creates a sound signal of a guiding sound whose frequency characteristic has been processed.

### Advantage of the Sixth Embodiment

As described above, the terminal device 60 according to the sixth embodiment transfers the direction of the target by processing the frequency characteristic of the sound from among the attributes of the sound. Accordingly, in a similar manner as in the first embodiment, a user can perceive whether he or she faces the target without perceiving the slight difference between the tempos of the sound. Accordingly, the terminal device 60 according to the sixth embodiment can accurately transfer the direction of the target. Furthermore, the terminal device 60 according to the sixth embodiment can process the frequency characteristic without using the head-related transfer function; therefore, the terminal device 60 can be preferably used not only when a stereo output is used but also when a monophonic output is used.

### Application Example of the Sixth Embodiment

In the sixth embodiment, a case has been described in which, by applying a gain to each frequency component of the guiding sound, the frequency characteristic of the sound is processed such that a user can easily perceive the sound; however, the device disclosed in the present invention is not limited thereto. For example, by applying a gain to each frequency component of a guiding sound, the frequency characteristic of the sound can also be processed such that a user hardly perceive the sound.

FIG. 11 is a schematic diagram illustrating the frequency characteristic of a sound and a regression line. The lateral axis of the graph illustrated in FIG. 11 indicates the frequency (Hz). The vertical axis of the graph illustrated in FIG. 11 indicates the power (dB). The broken lines indicated by reference numerals 65 and 66 illustrated in FIG. 11 indicate the frequency characteristic of the sound. The solid lines indicated by reference numerals 65a and 66a illustrated in FIG. 11 indicate the regression line of the frequency characteristic of the sound.

As illustrated in FIG. 11, because a high-frequency-bandwidth sound is hard for a human to hear, the following effect can be obtained by making the gradient of the frequency characteristic of a sound small as the absolute value of the orientation (Φ) of a user with respect to the target increases. Specifically, when controlling the gradient of the frequency characteristic of the sound in the above-described manner, it is possible to allow a user to quickly perceive a sound only when the user faces or substantially faces the target. In the example illustrated in FIG. 11, if the absolute value of the orientation (Φ) of a user with respect to the target is large, a gain is multiplied such that the gradient of the regression line 65a of the frequency characteristic of a sound becomes the gradient of the regression line 66a of the frequency characteristic of the sound. Accordingly, the frequency characteristic 65 of the sound becomes the frequency characteristic 66 of the sound, thus weakening the sound.

When controlling such a gradient, the degree-of-processing determining unit 61 determines an inclination control level of a supplied gain to be applied to the frequency characteristic (T) of the sound in accordance with the orientation of the terminal with respect to the target, i.e., the orientation of the user with respect to the target, calculated by the orientation calculating unit 14.

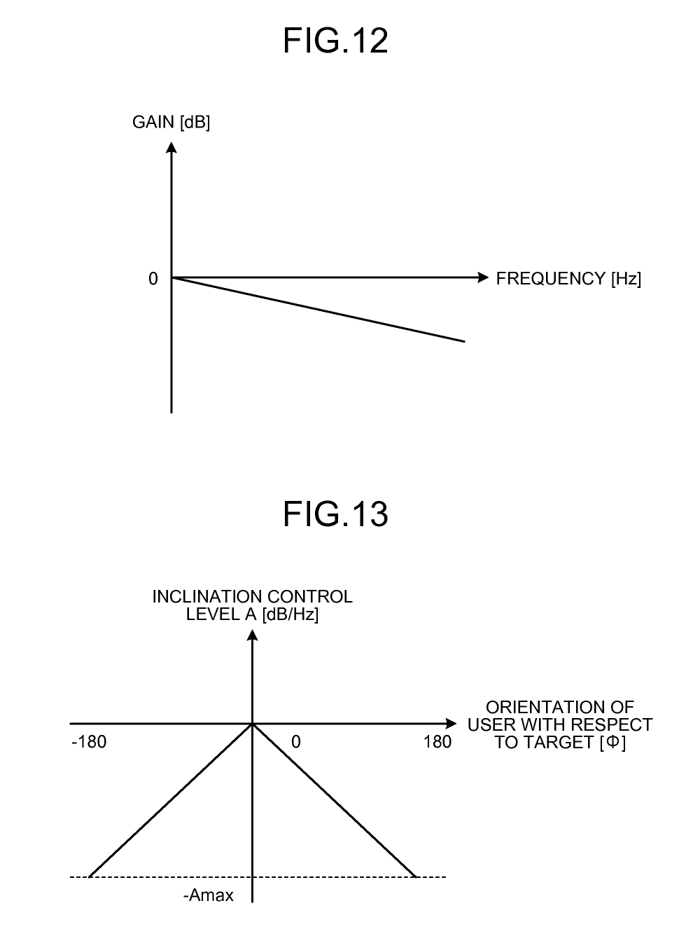

FIG. 12 is a schematic diagram illustrating an example of gain being applied to the frequency component of a guiding sound. The lateral axis of the graph illustrated in FIG. 12 indicates the frequency (Hz). The left end thereof is assumed to indicate the minimum audible value. The vertical axis of the graph illustrated in FIG. 12 indicates the gain. In the example illustrated in FIG. 12, a case is illustrated in which an inclination control level of the gain to be applied to the frequency component of the guiding sound is the maximum inclination control level Amax. As illustrated in FIG. 12, the maximum gain Amax is set such that the gain of the frequency bandwidth that can hardly be perceived by a human is set to high. Furthermore, the maximum gain Amax is set such that, by applying the maximum gain Amax to the sound signal of the guiding sound, the sound in the high frequency region is hardly perceived.

FIG. 13 is a schematic diagram illustrating an example of processing the frequency characteristic of a sound. The lateral axis of the graph illustrated in FIG. 13 indicates the orientation (Φ) of a user with respect to the target. The vertical axis of the graph illustrated in FIG. 13 indicates the inclination control level A (dB/Hz) of the supplied gain. In the example illustrated in FIG. 13, a case is assumed in which, when the target is located in front of a user, i.e., Φ (t)=0, the inclination control level (A) of the supplied gain is set to the minimum (=0) and when the target is located right behind a user, the inclination control level (Amax=100%) is set to the maximum.

In the example illustrated in FIG. 13, if the orientation (Φ) of a user with respect to the target satisfies “0≦Φ”, the degree-of-processing determining unit 61 determines an inclination control level A in accordance with the calculation equation 1 “A(t)=−(Amax/180)Φ(t)” for the inclination control level of the supplied gain. Furthermore, if the orientation (Φ) of a user with respect to the target satisfies “Φ<0”, the degree-of-processing determining unit 61 determines an inclination control level A in accordance with the calculation equation 2 “A(t)=−Amax+(Amax/180)Φ(t)” for the inclination control level of the supplied gain. If the inclination control level A is determined in this way, the sound can be weakened by applying to the original sound a larger gain that degrades the sound in the high frequency region except for a case in which a user faces or substantially faces the target. Accordingly, when the state is such that the target is shifting from the front of a user or becomes shifted from the front of the user, this state can be enhanced.

Then, the output control unit 62 changes the frequency characteristic of the guiding sound stored in the guiding sound storing unit 17 in accordance with the inclination control level A of the supplied gain determined by the degree-of-processing determining unit 61. For example, the output control unit 62 calculates a supplied gain e (f) to be supplied to the sound signal of the guiding sound in accordance with the calculation equation “e(f)=10̂((f*A)/100/20)” for the supplied gain. Thereafter, the output control unit 62 performs the same processes as those described in the sixth embodiment.

### Advantage of the Application Example

As described above, the terminal device 60 according to the application example transfers the direction of the target by processing the frequency characteristic of the sound from among the attributes of the sound. Accordingly, in a similar manner as in the sixth embodiment, a user can perceive whether he or she faces the target without perceiving the slight difference between the frequency characteristics of the sound. Accordingly, the terminal device 60 according to the application example can accurately transfer the direction of the target. Furthermore, the terminal device 60 according to the application example can process the frequency characteristic without using the head-related transfer function; therefore, the terminal device 60 can be preferably used not only when a stereo output is used but also when a monophonic output is used.

### [g] Seventh Embodiment

In the sixth embodiment, a case has been described in which the direction of the target is transferred by processing the frequency characteristic of the sound from among the attributes of the sound; however, another attribute of a sound can also be used. Accordingly, in a seventh embodiment, a case will be described in which the direction of the target is transferred by processing the bandwidth of the sound from among the attributes of the sound.

In the seventh embodiment, the functioning units other than the degree-of-processing determining unit 15 and the output control unit 18 illustrated in FIG. 1 have the same functions as those described in the first embodiment; therefore, a description thereof is omitted here. Furthermore, in the seventh embodiment, in order to distinguish the terminal device, the degree-of-processing determining unit, and the output control unit described in the seventh embodiment from those in the first to sixth embodiments, a description will be given by assigning reference numeral “70” to a terminal device, reference numeral “71” to a degree-of-processing determining unit, and reference numeral “72” to an output control unit.

The degree-of-processing determining unit 71 determines the degree of processing of the bandwidth (W) of the sound in accordance with the orientation of the terminal with respect to the target, i.e., the orientation of a user with respect to the target, calculated by the orientation calculating unit 14. The “degree of processing” mentioned here indicates the control level of the ratio (%) of an output bandwidth with respect to the maximum bandwidth Wmax. The maximum bandwidth Wmax is assumed to be the bandwidth of the original sound.

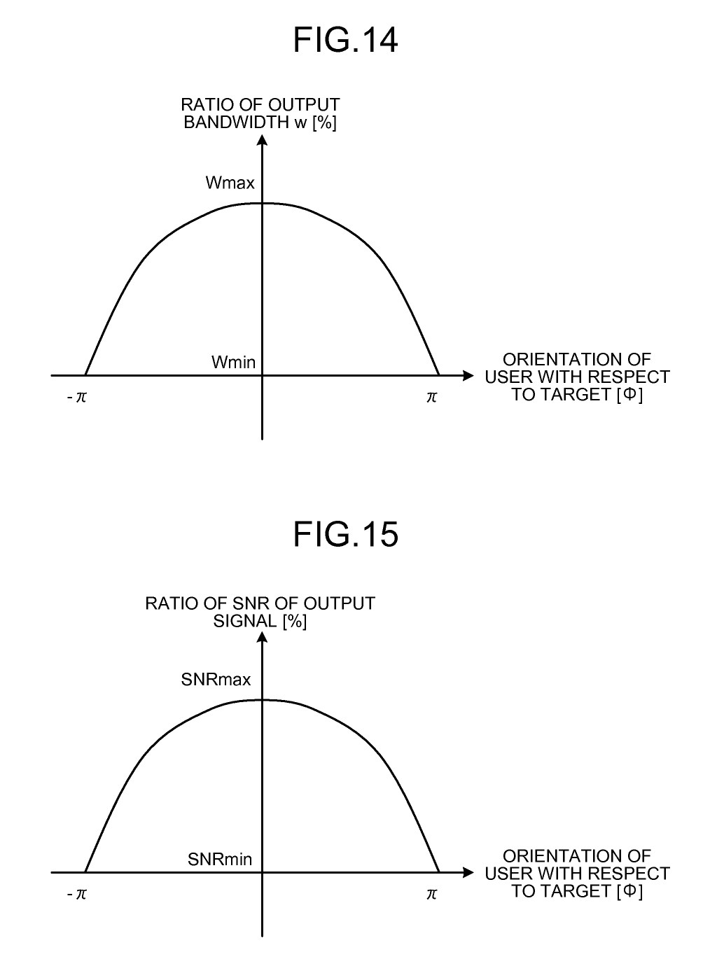

FIG. 14 is a schematic diagram illustrating an example of processing the bandwidth of a sound. The lateral axis of the graph illustrated in FIG. 14 indicates the orientation (Φ) of a user with respect to the target. The vertical axis of the graph illustrated in FIG. 14 indicates the ratio (w) of an output bandwidth. In the example illustrated in FIG. 14, a case is assumed in which, when the target is located in front of a user, i.e., Φ (t)=0, the ratio (w) of an output bandwidth is set to the maximum bandwidth (Wmax=100%).

In the example illustrated in FIG. 14, the degree-of-processing determining unit 71 determines the ratio of the output bandwidth in accordance with the calculation equation “w(Φ)=(Wmax−Wmin)sin(Φ/2+π/2)+Wmin” for the ratio (w) of the output bandwidth. Specifically, as the absolute value of the orientation (Φ) of a user with respect to the target increases, the degree-of-processing determining unit 71 increases the control level of the ratio (w) of the output bandwidth. If the ratio (w) of the output bandwidth is determined in this way, it is possible to allow a user to perceive a natural sound with its original bandwidth only when the user faces or substantially faces the target. In contrast, when the user does not face nor substantially face the target, it is possible to allow the user to perceive a weakened sound by narrowing the bandwidth compared with the original sound. Accordingly, when the state is such that the target is shifting from the front of a user or becomes shifted from the front of the user, this state can be enhanced.

The output control unit 72 changes the bandwidth of the guiding sound stored in the guiding sound storing unit 17 in accordance with the ratio of the output bandwidth determined by the degree-of-processing determining unit 71. Specifically, the output control unit 72 obtains a frequency component by performing a time frequency conversion on the sound signal of the guiding sound stored in the guiding sound storing unit 17. Such a frequency component is represented as a complex number for each frequency (Hz). In the following, a description will be given by representing the number of divisions of a frequency component divided by a predetermined bandwidth (hereinafter, referred to as the “number of bandwidth divisions”) as N and by representing the k^{th} (k=0, . . . , N−1) bandwidth frequency component as S (k). By using a ROUND function that outputs an integer by rounding off decimals, the output control unit 72 thins out a part of the frequency component in accordance with the ratio of the output bandwidth of the frequency component of the guiding sound. Specifically, by using “q=round(N*w/100)”, the output control unit 72 calculates S′″ (k)=S(k) 0 for “k=0, . . . , q−1” and calculates S′″ (k)=0 for “k=q, . . . , N−1”. By doing so, from among the frequency components of the original sound, the frequency components of “k=q, . . . , N−1” are thinned out. Then, by performing the frequency-time conversion on S′″(k), the output control unit 72 creates a sound signal of the guiding sound in which the frequency components are thinned out to the ratio (w) of the output bandwidth.

### Advantage of the Seventh Embodiment

As described above, the terminal device 70 according to the seventh embodiment transfers the direction of the target by processing the bandwidth (W) of the sound from among the attributes of the sound. Accordingly, in a similar manner as in the first embodiment, a user can perceive whether he or she faces the target without perceiving the slight difference between the bandwidths of the sound. Accordingly, the terminal device 70 according to the seventh embodiment can accurately transfer the direction of the target. Furthermore, the terminal device 70 according to the seventh embodiment can process the bandwidth of the sound without using the head-related transfer function; therefore, the terminal device 70 can be preferably used not only when a stereo output is used but also when a monophonic output is used.

### [h] Eighth Embodiment

In the seventh embodiment, a case has been described in which the direction of the target is transferred by processing the bandwidth of the sound from among the attributes of the sound; however, another attribute of a sound can also be used. Accordingly, in an eighth embodiment, a case will be described in which the direction of the target is transferred by processing the signal to noise ratio (SNR) of the sound from among the attributes of the sound.

In the eighth embodiment, the functioning units other than the degree-of-processing determining unit 15 and the output control unit 18 illustrated in FIG. 1 have the same functions as those described in the first embodiment; therefore, a description thereof is omitted here. Furthermore, in the eighth embodiment, in order to distinguish the terminal device, the degree-of-processing determining unit, and the output control unit described in the eighth embodiment from those in the first to sixth embodiments, a description will be given by assigning reference numeral “80” to a terminal device, reference numeral “81” to a degree-of-processing determining unit, and reference numeral “82” to an output control unit.

The degree-of-processing determining unit 81 determines the degree of processing related to the SNR of the sound in accordance with the orientation of the terminal with respect to the target, i.e., the orientation of a user with respect to the target, calculated by the orientation calculating unit 14. The “degree of processing” mentioned here indicates the control level of the ratio (%) of the SNR of an output signal with respect to the maximum SNRmax. The maximum SNRmax is assumed to be the SNR of the original sound.

FIG. 15 is a schematic diagram illustrating an example of processing the SNR of a sound. The lateral axis of the graph illustrated in FIG. 15 indicates the orientation (Φ) of a user with respect to the target. The vertical axis of the graph illustrated in FIG. 15 indicates the ratio (%) of the SNR of the output signal. In the example illustrated in FIG. 15, a case is assumed in which, when the target is located in front of the user, i.e., Φ (t)=0, the ratio of the SNR of the output signal is set to the maximum SNR (SNRmax=100%).

In the example illustrated in FIG. 15, the degree-of-processing determining unit 81 determines the ratio of the SNR of the output signal in accordance with the calculation equation “SNR(Φ)=(SNRmax−SNRmin)sin(Φ)/2+π/2)+SNRmin” for the ratio of the SNR of the output signal. Specifically, as the absolute value of the orientation (Φ) of a user with respect to the target increases, the degree-of-processing determining unit 81 increases the control level of the ratio of the SNR of the output signal. If the ratio of the SNR of the output signal is determined in this way, it is possible to allow a user to perceive a natural sound only when the user faces or substantially faces the target. In contrast, when the user does not face nor substantially face the target, it is possible to allow the user to perceive a degraded sound by superimposing white noise on the original sound. Accordingly, when the state is such that the target is shifting from the front of a user or becomes shifted from the front of the user, this state can be enhanced.

The output control unit 82 superimposes white noise on the guiding sound stored in the guiding sound storing unit 17 in accordance with the ratio of the SNR of the output signal determined by the degree-of-processing determining unit 81. The white noise mentioned here is noise whose power is uniform in the entire frequency bandwidth of which amplitude components have a normal distribution.

Specifically, the output control unit 82 calculates, using Equation (3) described below, the magnitude S1 (dB) of the sound signal of the guiding sound stored in the guiding sound storing unit 17. The symbol “Q” in Equation (3) represents the number of frame samples. The output control unit 82 creates white noise w (t) by using a conventional technology for creating random numbers having a normal distribution. Then, by using Equation (4) below, the output control unit 82 adjusts the magnitude of the white noise such that it becomes SNR (Φ) of the output signal determined by the degree-of-processing determining unit 81. In Equation (4), “w (t)” represents the sample of the sound signal of white noise that has not been processed and “w′ (t)” represents the sample of the sound signal of white noise that has been processed. Thereafter, the output control unit 62 superimposes the processed white noise w′ (t) on the sound signal s (t) of the guiding sound so that it outputs an output signal w′ (t).

$$\begin{matrix}Sl = 10 * log 10 ( \frac{1}{Q} {\sum }_{0}^{Q - 1} {s ( t )}^{2} ) & ( 3 ) \\ {w}^{′} ( t ) = {10}^{( \frac{Sl - SNTR ( φ )}{20} )} w ( t ) & ( 4 )\end{matrix}$$

### Advantage of the Eighth Embodiment

As described above, the terminal device 80 according to the eighth embodiment transfers the direction of the target by processing the SNR of the sound from among the attributes of the sound. Accordingly, in a similar manner as in the first embodiment, a user can perceive whether he or she faces the target without perceiving the slight difference between the SNRs of the sound. Accordingly, the terminal device 80 according to the eighth embodiment can accurately transfer the direction of the target. Furthermore, the terminal device 80 according to the eighth embodiment can process the SNR without using the head-related transfer function; therefore, the terminal device 80 can be preferably used not only when a stereo output is used but also when a monophonic output is used.

### [i] Ninth Embodiment

In the above explanation, the embodiments of the present invention have been described; however, the present invention can be implemented with various kinds of embodiments other than the embodiments described above. Therefore, another embodiment included in the present invention will be described below.

### (1) Application Example

For example, in the first to eighth embodiments, each embodiment is separately implemented; however, it is also possible to implement two or more embodiments in combination from among the embodiments. Specifically, the disclosed device can determine the degree of processing related to the attributes by using at least one of or a combination of any of the distance, the direction, the volume, the pitch, the tempo, the frequency characteristic, the bandwidth, or the SNR of the sound. By doing so, the disclosed device can create, in a multifaceted manner, a guiding sound such that a user can easily perceive whether the target faces the front of the user or whether the target is moving closer to the front of the user. Accordingly, the disclosed device can accurately transfer the direction of the target.

The components of each device illustrated in the drawings are not necessarily physically configured as illustrated in the drawings. In other words, the specific shape of a separate or integrated device is not limited to the drawings; thus, all or part of the device can be configured by functionally or physically separating or integrating any of the units depending on various loads or use conditions. For example, the location acquisition unit 12, the orientation acquisition unit 13, the orientation calculating unit 14, the degree-of-processing determining unit 15, and the output control unit 18 can be connected via a network as external units of the terminal device. Furthermore, it is also possible to implement the function of the terminal device by allowing other devices to have the location acquisition unit 12, the orientation acquisition unit 13, the orientation calculating unit 14, the degree-of-processing determining unit 15, and the output control unit 18 and by allowing these units to be connected via a network and to cooperate with each other. Furthermore, it is also possible to implement the function of the terminal device by allowing other devices to have all or part of the transfer characteristic storing unit 16 or the guiding sound storing unit 17; to be connected to a network; and to cooperate with each other.

### (2) Hardware Configuration of a Terminal Device

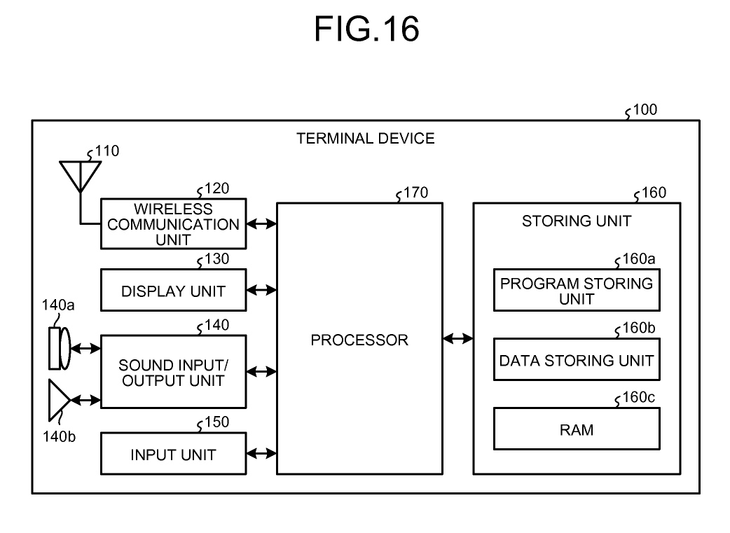

In the following, an example of hardware configuration of the terminal device according to the first embodiment will be described with reference to FIG. 16. FIG. 16 is a schematic diagram illustrating an example of the hardware configuration of the terminal device. As illustrated in FIG. 16, a terminal device 100 includes an antenna 110, a wireless communication unit 120, a display unit 130, a microphone 140a, a speaker 140b, a sound input/output unit 140, an input unit 150, a storing unit 160, and a processor 170.

From among the above devices, the wireless communication unit 120, the display unit 130, the sound input/output unit 140, the input unit 150, and the storing unit 160 are connected to the processor 170. Furthermore, the antenna 110 is connected to the wireless communication unit 120. Furthermore, the microphone 140a and the speaker 140b are connected to the sound input/output unit 140.

Although not illustrated in FIG. 1, the wireless communication unit 120 corresponds to, for example, a communication control unit included in the terminal device 10. The display unit 130 corresponds to, for example, the display unit 11b illustrated in FIG. 1. The sound input/output unit 140, the microphone 140a, and the speaker 140b correspond to, for example, the sound output unit 19 illustrated in FIG. 1. The input unit 150 corresponds, for example, to the input unit 11a illustrated in FIG. 1.

The storing unit 160 and the processor 170 implement the function performed by, for example, the location acquisition unit 12, the orientation acquisition unit 13, the orientation calculating unit 14, the degree-of-processing determining unit 15, the transfer characteristic storing unit 16, the guiding sound storing unit 17, and the output control unit 18 illustrated in FIG. 1. Specifically, a program storing unit 160a in the storing unit 160 stores therein various programs, such as navigation programs, that implement a process illustrated in, for example, FIG. 4. Then, by reading each program stored in the program storing unit 160a and executing it, the processor 170 creates processes that implement each function described above. Furthermore, a data storing unit 160b stores therein various data that is used to perform a process illustrated in, for example, FIG. 4. When performing a process illustrated in, for example, FIG. 4, a random access memory (RAM) 160c has a storage area that is used to perform a process created by the processor 170.

Furthermore, the navigation programs are not necessarily stored in the storing unit 160 from the beginning. For example, each program is stored in a “portable physical medium”, such as a memory card inserted into the terminal device 100. Then, the terminal device 100 can be configured such that it obtains each program from the portable physical medium and executes the programs. Alternatively, each program is stored in, for example, another computer or a server device that is connected to the terminal device 100 via a public circuit, the Internet, a LAN, a WAN, or the like. Then the terminal device 100 obtains each program from the other computer or the server device and executes the programs.

According to the terminal device disclosed in the present invention target, an advantage is provided in that the direction of the target is accurately transferred.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A terminal device comprising:
a calculating unit that calculates an orientation of a device with respect to a target;
a determining unit that determines a degree of processing related to an attribute of a sound that indicates the target in accordance with the orientation calculated by the calculating unit; and
an output control unit that controls output of the sound in accordance with the degree of processing determined by the determining unit.

2. The terminal device according to claim 1, wherein, as the orientation of the front of the device is shifted with respect to the target, the determining unit increases the degree of processing related to the attribute of the sound.

3. The terminal device according to claim 1, wherein, if the orientation of the front of the device is shifted with respect to the target within a predetermined range, as the orientation of the front of the device within the predetermined range is shifted, the determining unit increases the degree of processing compared with that in other ranges.

4. The terminal device according to claim 1, wherein the determining unit determines the degree of processing related to at least one attribute from among a distance, a direction, a volume, a pitch, a tempo, a frequency characteristic, a bandwidth, and an SNR of a sound.

5. A mobile terminal device comprising:
a calculating unit that calculates an orientation of a device with respect to a target;
a determining unit that determines a degree of processing related to an attribute of a sound that indicates the target in accordance with the orientation calculated by the calculating unit; and
an output control unit that controls output of the sound in accordance with the degree of processing determined by the determining unit.

6. A non-transitory computer readable storage medium having stored therein a navigation program causing a terminal device to execute a process comprising:
calculating an orientation of a device with respect to a target;
determining a degree of processing related to an attribute of a sound that indicates the target in accordance with the calculated orientation; and
controlling output of the sound in accordance with the determined degree of processing.
